(19) United States
(12) Patent Application Publication
(10) Pub. No.: US 2018/0321784 A1
(43) Pub. Date: Nov. 8, 2018

(54) PRESSURE SENSOR AND COMPOSITE ELEMENT HAVING SAME

(71) Applicant: MODA-INNOCHIPS CO., LTD., Ansan-Si, Gyeonggi-Do (KR)

(72) Inventors: In Kil PARK, Seongnam-Si, Gyeonggi-Do (KR); Jun Ho JUNG, Siheung-Si, Gyeonggi-Do (KR)

(21) Appl. No.: 15/773,999

(22) PCT Filed: Oct. 28, 2016
(86) PCT No.: PCT/KR2016/012302

§ 371 Date: May 4, 2018

(30) Foreign Application Priority Data
Nov. 5, 2015 (KR) 10-2015-0155132
Oct. 7, 2016 (KR) 10-2016-0129998

(51) Int. Cl. G06F 3/041; G01L 1/16; G06K 9/00

(52) U.S. Cl. CPC G06F 3/0414; G06K 9/00053; G06K 9/0002; G01L 1/16

(57) ABSTRACT

The present invention proposes a pressure sensor and a complex device provided with the same, the pressure sensor including: first and second electrode layers provided to be spaced apart from each other and respectively including first and second electrodes facing each other; and a piezoelectric layer provided between the first and second electrode layers, wherein the piezoelectric layer includes a plurality of plate-like piezoelectric bodies in a polymer.

### TECHNICAL FIELD

The present invention relates to a pressure sensor, and more particularly, to a piezoelectric pressure sensor and a complex device having the same.

### BACKGROUND ART

In general, keyboards have been widely used in apparatuses, such as PCs and network terminals, as a means for interface between an apparatus and a user. Most keyboards are provided with a mechanical configuration, in which springs and switches are installed below keys manufactured in the form of an injection molded article, and key input is performed by a user hitting the keys with a certain force to win the elastic force of the springs and allow switches to be operated.

Meanwhile, besides the keyboards provided with such a mechanical configuration, keyboards employing a touch panel type have emerged. The keyboards employing a touch panel type each have a technical means which detects and recognizes touch or non-touch of a finger or pen, using the detection of human body current due to the touch or a change in pressure, temperature, or the like. In particular, input apparatuses, which detect touch or non-touch of the human body or a pen using a pressure change, have been spotlighted.

There are various types of pressure sensors including a piezoelectric-type pressure sensor using a piezoelectric body. That is, a pressure sensor is implemented by using a piezoelectric body which has a predetermined thickness and formed by using piezoelectric ceramic powder. However, when the piezoelectric powder is used, there are limitations in that since piezoelectric performance is low, and an output value is thereby low, a sensing error occurs. In addition, there is a limitation in that a sensing error is caused by an irregular voltage output due to irregular mixing of piezoelectric powder. In addition, the piezoelectric body using piezoelectric ceramic powder has a limitation in that it is not easy to apply the piezoelectric body using the powder to various apparatuses due to high brittleness.

### RELATED ART DOCUMENTS

Korean Patent Registration No. 10-1094165

### DISCLOSURE OF THE INVENTION

### Technical Problem

The present invention provides a pressure sensor capable of reducing sensing error and improving brittleness.

The present invention provides a complex device provided with a pressure sensor in which at least one component having a function different from that of the pressure sensor is integrated.

### Technical Solution

In accordance with an aspect of the present invention, a pressure sensor includes: first and second electrode layers provided to be spaced apart from each other and respectively including first and second electrodes facing each other; and a piezoelectric layer provided between the first and second electrode layers, wherein the piezoelectric layer includes a plurality of plate-like piezoelectric body in a polymer.

The piezoelectric bodies are arranged in plurality in one direction and another direction crossing each other in a horizontal direction and be arranged in plurality in a vertical direction.

The piezoelectric bodies are provided to have densities of 30% to 99%.

The piezoelectric bodies are single crystals.

The piezoelectric bodies each include: a seed composition formed of: an orientation raw material composition composed of a piezoelectric material having a Perovskite crystalline structure; and an oxide which is distributed in the orientation raw material composition and has a general formula ABO₃ (A is a bivalent metal element, and B is a tetravalent metal element).

In accordance with another aspect of the present invention, a pressure sensor includes: first and second electrode layers provided to be spaced apart from each other and respectively including first and second electrodes facing each other; a piezoelectric layer provided between the first and second electrode layers; and a plurality of cutaway portions formed with a predetermined width and at a predetermined depth in the piezoelectric layer.

The cutaway portions are formed to a depth of 50% to 100% of a thickness of the piezoelectric layer.

The cutaway portions are formed such that at least one thereof corresponds to an interval between the plurality of first and second electrodes which are arranged at predetermined intervals.

The pressure sensor further includes an elastic layer provided inside the cutaway portions.

The piezoelectric layer is single crystalline.

The piezoelectric layer includes: a seed composition formed of: an orientation raw material composition composed of a piezoelectric material having a Perovskite crystalline structure; and an oxide which is distributed in the orientation raw material composition and has a general formula ABO₃ (A is a bivalent metal element, and B is a tetravalent metal element).

In accordance with yet another aspect of the present invention, a complex device includes: a pressure sensor in accordance with the aspect and the another aspect; and at least one functional part having a function different from that of the pressure sensor

The functional part includes a piezoelectric device provided on one side of the pressure sensor; and a vibration plate provided on one side of the piezoelectric device.

The piezoelectric device is used as a piezoelectric vibration apparatus or a piezoelectric acoustic apparatus according to a signal applied thereto.

The functional part is provided on one side of the pressure sensor and includes at least one among an NFC, a WPC, and a MST each of which includes at least one antenna pattern.

The functional part may include: a piezoelectric device provided on one surface of the pressure sensor; a vibration plate provided on one surface of the piezoelectric device; and at least one among an NFC, a WPC, and an MST which are provided on the other surface of the pressure sensor or on one surface of the vibration plate.

The complex device includes a fingerprint detection part electrically connected to the pressure sensor and configured to measure, from the pressure sensor, a difference in acoustic impedance generated by an ultrasonic signal at valleys and ridges of the fingerprint and thereby detects the fingerprint.

### Advantageous Effects

A pressure sensor in accordance with an exemplary embodiment may have a piezoelectric layer between first and second electrode layers spaced apart from each other, and the piezoelectric layer may be provided with a plurality of plate-like single-crystal piezoelectric bodies. Since the plate-like piezoelectric bodies are used, the piezoelectric characteristics are better than typical piezoelectric powder. Thus, a minute pressure may also be easily sensed, and the sensing efficiency may thereby be improved.

In addition, in the pressure sensor in accordance with an exemplary embodiment, the piezoelectric layer may have a cutaway portion for each cell unit, and an elastic layer may further be formed in the cutaway portions. The plurality of cutaway portions are formed in the piezoelectric layer, and thus, the pressure sensor may have a flexible characteristic.

In addition, the pressure sensor in accordance with an exemplary embodiment may be integrated with a piezoelectric device functioning as a piezoelectric acoustic device or a piezoelectric vibration device, and may also be integrated with NFC, WPC, and MST. In addition, the pressure sensor may also be used as a fingerprint recognition sensor.

### BRIEF DESCRIPTION OF THE DRAWINGS

FIG. 1 is a cross-sectional view of a pressure sensor in accordance with a first exemplary embodiment;

FIGS. 2 and 3 are schematic views of first and second electrode layers of a pressure sensor;

FIG. 4 is a cross-sectional view of a pressure sensor in accordance with a second exemplary embodiment;

FIGS. 5 and 6 are planar and cross-sectional photographs of a pressure sensor in accordance with a second exemplary embodiment;

FIG. 7 is a cross-sectional view of a pressure sensor in accordance with a third exemplary embodiment;

FIGS. 8 to 12 are views of an integrated complex device in accordance with various exemplary embodiments;

FIG. 13 is a configuration diagram of a fingerprint recognition sensor employing a pressure sensor in accordance with an exemplary embodiment; and

FIG. 14 is a cross-sectional view of a pressure sensor in accordance with a modified exemplary embodiment.

### DETAILED DESCRIPTION

Hereinafter, exemplary embodiments of the present invention will be described in detail with reference to the accompanying drawings. The present invention may, however, be embodied in different forms and should not be construed as limited to the embodiments set forth herein. Rather, these embodiments are provided so that this invention will be thorough and complete, and will fully convey the scope of the present invention to those skilled in the art.

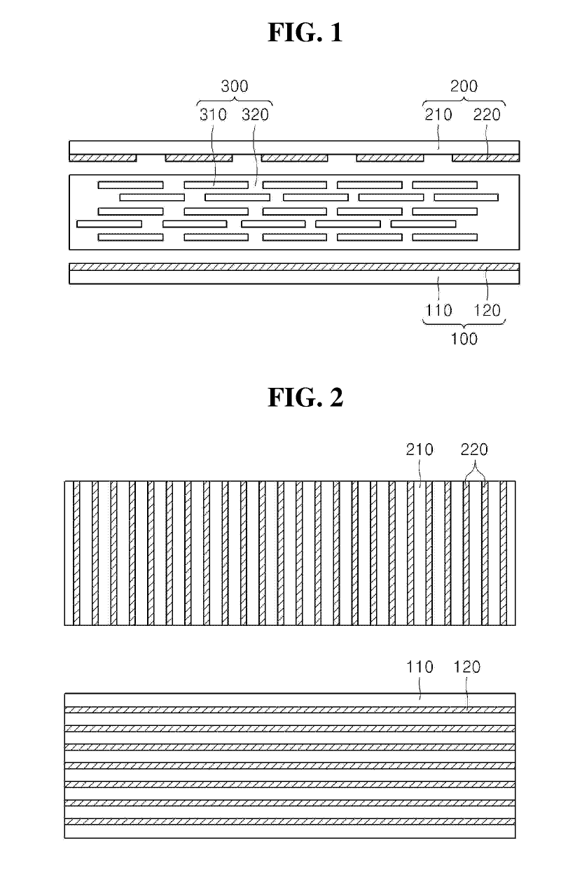

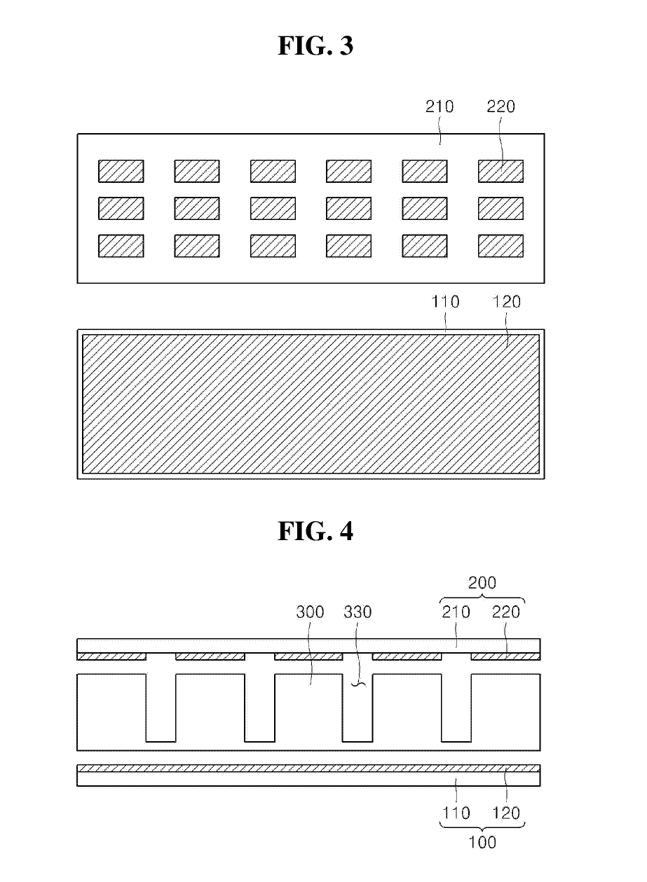

FIG. 1 is a cross-sectional view of a pressure sensor in accordance with a first exemplary embodiment, FIGS. 2 and 3 are schematic views of first and second electrode layers of a pressure sensor.

Referring to FIG. 1, a pressure sensor in accordance with an exemplary embodiment includes: first and second electrode layers 100 and 200 which are spaced apart from each other; and a piezoelectric layer 300 provided between the first and second electrode layers 100 and 200. Here, the piezoelectric layer 300 may be provided with a plurality of plate-like piezoelectric bodies 310 having a predetermined thickness.

1. Electrode Layer

The first and second electrode layers 100 and 200 are spaced apart from each other in the thickness direction (that is, in the vertical direction) and the piezoelectric layer 300 is provided therebetween. The first and second electrode layers 100 and 200 may include: first and second support layers 110 and 210; and first and second electrodes 10 and 220 which are respectively formed on the first and second support layers 110 and 210. That is, the first and second support layers 110 and 210 are formed to be spaced a predetermined distance apart from each other, and the first and second electrodes 120 and 220 are respectively formed on the surfaces of the support layers in the direction facing each other. At this point, the first and second electrodes 120 and 220 are formed to be in contact with the piezoelectric layer 300. Accordingly, the pressure sensor may be implemented by the first support layer 110, the first electrode 120, the piezoelectric layer 300, the second electrode 220, and the second support layer 210 being stacked in the thickness direction from the bottom side. Here, the first and second support layers 110 and 210 support the first and second electrodes 120 and 220 so that the first and second electrodes 120 and 220 are respectively formed on one surface of the first and second support layers 110 and 210. To this end, the first and second support layers 110 and 210 may be provided in a plate shape having a predetermined thickness. In addition, the first and second support layers 110 and 210 may also be provided in a film shape so as to have flexibility. The first and second support layers 110 and 210 may be formed by using a liquid polymer, such as silicone, urethane, and polyurethane, and may be formed by using a prepolymer formed by using a liquid photocurable monomer, an oligomer, a photoinitiator, and additives. In addition, optionally, the first and second support layers 110 and 210 may be transparent or also be opaque.

Meanwhile, the first and second electrodes 120 and 220 may be formed of a transparent conductive material such as an indium tin oxide (ITO) and an antimony tin oxide (ATO). However, besides such materials, the first and second electrodes 120 and 220 may also be formed of another transparent conductive material, and also be formed of an opaque conductive material such as silver (Ag), platinum (Pt) and copper (cu). Also, the first and second electrodes 120 and 220 may be formed in directions crossing each other. For example, the first electrode 120 may be formed in one direction so as to have a predetermined width, and further formed at intervals in another direction. The second electrode 220 may be formed in another direction perpendicular to the one direction so as to have a predetermined width, and further formed at intervals in the one direction perpendicular to the another direction. That is, as illustrated in FIG. 2, the first and second electrodes 120 and 220 may be formed in directions perpendicular to each other. For example, the first electrode 120 may be formed to have predetermined widths in the horizontal direction and further formed in plurality in the vertical direction to be arranged at intervals, and the second electrode 220 may be formed to have predetermined widths in the vertical direction and further formed in plurality in the horizontal direction to be arranged at intervals. Here, the widths of the first and second electrodes 120 and 220 may be equal to or greater than the respective intervals therebetween. Of course, the widths of the first and second electrodes 120 and 220 may also be smaller than the intervals therebetween, but preferably, the widths are larger than the intervals. For example, the ratio of the width to the interval in each of the first and second electrodes 120 and 220 may be 10:1 to 0.5:1. That is, when the interval is 1, the width may be 10 to 0.5. Also, the first and second electrodes 120 and 220 may be formed in various shapes besides such a shape. For example, as illustrated in FIG. 3, any one of the first and second electrode 120 and 220 may also be entirely formed on the support layer, and the other may also be formed in a plurality of approximately rectangular patterns having predetermined widths and predetermined intervals in one direction and another direction. That is, a plurality of first electrodes 120 may be formed in approximately rectangular patterns, and the second electrode 220 may be entirely formed on the second support layer 210. Of course, besides rectangles, various patterns such as circles and polygons may be used. In addition, any one of the first and second electrodes 120 and 220 may also be entirely formed on the support layer, and the other may be formed in a lattice shape which extends in one direction and another direction. Meanwhile, the first and second electrodes 120 and 220 may be formed in a thickness, for example, 0.1 μm to 10 μm, and the first and second electrodes 120 and 220 may be provided at intervals such as 1 μm to 500 μm. Here, the first and second electrodes 120 and 220 may be in contact with the piezoelectric layer 300. Of course, the first and second electrodes 120 and 220 maintain the states of being spaced a predetermined distance apart from the piezoelectric layer 300, and when a predetermined pressure, such as user's touch input, is applied, at least any one of the first and second electrodes 120 and 220 may locally be in contact with the piezoelectric layer 300. At this point, the piezoelectric layer 300 may also be compressed to a predetermined depth.

2. Piezoelectric Layer

The piezoelectric layer 300 is provided in a predetermined thickness between the first and second electrode layers 100 and 200, and may be provided in a thickness such as 10 μm to 500 μm. The piezoelectric layer 300 may be formed by using piezoelectric bodies 310, which has an approximately rectangular plate shape with a predetermined thickness, and a polymer 320. That is, a plurality of plate-like piezoelectric bodies 310 are provided in the polymer 320, whereby the piezoelectric layer 300 may be formed. Here, the piezoelectric bodies 310 may be formed by using a piezoelectric material based on PZT (Pb, Zr, Ti), NKN (Na, K, Nb), and BNT (Bi, Na, Ti). Of course, the piezoelectric body 310 may be formed of various piezoelectric materials, and may include: barium titanate, lead titanate, lead zirconate titanate, potassium niobate, lithium niobate, lithium tantalate, sodium tungstate, zinc oxide, potassium sodium niobate, bismuth ferrite, sodium niobate, bismuth titanate, or the like. However, the piezoelectric body 310 may be formed of a fluoride polymer or a copolymer thereof. The plate-like piezoelectric bodies 310 may be formed in an approximately rectangular plate shape which has predetermined lengths in one direction and another direction perpendicular to the one direction and has a predetermined thickness. For example, the piezoelectric bodies 310 may be formed in a size of 3 μm to 5000 μm. The piezoelectric bodies 310 may be arranged in plurality in one direction and another direction. That is, the plurality of piezoelectric bodies may be arranged in the thickness direction (that is, in the vertical direction) between the first and second electrode layers 100 and 200 and a planar direction (that is, in the horizontal direction) perpendicular to the thickness direction. The piezoelectric bodies 310 may be arranged in a two or more layered structure, such as a five layered structure, in the thickness direction, but the number of layers is not limited. In order to form the piezoelectric bodies 310 in a plurality of layers in the polymer 320, various methods may be used. For example, a piezoelectric body layer with a predetermined thickness is formed on a polymer layer with a predetermined thickness, and the piezoelectric body layer is stacked in plurality, whereby the piezoelectric layer 300 may be formed. That is, the piezoelectric body layer is formed by disposing plate-like piezoelectric plates on a polymer layer which has a smaller thickness than the piezoelectric layer 300, and the piezoelectric layer 300 may be formed by stacking the plurality of piezoelectric body layers. However, the piezoelectric layer 300, in which the piezoelectric bodies 310 are formed in the polymer 320, may be formed through various methods. Meanwhile, preferably, the piezoelectric bodies 310 have the same size and are spaced the same distance apart from each other. However, the piezoelectric bodies 310 may also be provided in at least two or more sizes and two or more intervals. At this point, the piezoelectric bodies 310 may be formed with a density of 30% to 99%, and preferably provided in the same density in all regions. However, the piezoelectric bodies 310 may be provided such that at least one region thereof has a density of 60% or more. For example, when at least one region of the piezoelectric bodies 310 has a density 65% and at least another region has a density of 90%, a higher voltage may be generated in the region with the greater density. However, when the piezoelectric bodies have a density or 60% or more, a control unit may sufficiently sense the voltage generated in the piezoelectric layer. In addition, the piezoelectric bodies 310 in accordance with an exemplary embodiment have a superior piezoelectric characteristic because being formed in a single crystal form. That is, compared to a case of using typical piezoelectric powder, the plate-like piezoelectric bodies 310 are used, so that a superior piezoelectric characteristic may be obtained, and a pressure may thereby be detected even by a slight touch, and thus, an error in a touch input may be prevented. Meanwhile, the polymer 320 may include, but not limited to, at least one or more selected from the group consisting of epoxy, polyimide and liquid crystalline polymer (LCP). In addition, the polymer 320 may be formed of a thermoplastic resin. The thermoplastic resin may include, for example, one or more elected from the group consisting of novolac epoxy resin, phenoxy-type epoxy resin, BPA-type epoxy resin, BPFO-type epoxy resin, hydrogenated BPA epoxy resin, dimer acid modified epoxy resin, urethane modified epoxy resin, rubber modified epoxy resin and DCPD-type epoxy resin.

3. Another Example of Piezoelectric Body

Meanwhile, the piezoelectric body 310 may be formed by using a piezoelectric ceramic sintered body which is formed by sintering a piezoelectric ceramic composition including a seed composition composed of: an orientation raw material composition composed of a piezoelectric material having a Perovskite crystalline structure; and an oxide which is distributed in the orientation raw material composition and has a general formula of ABO₃ (A is a bivalent metal element, and B is a tetravalent metal element). Here, the orientation raw material composition may be formed by using a composition, in which a material having a crystalline structure different from the Perovskite crystalline structure forms a solid solution. For example, a PZT-based material, in which PbTiO₃ (PT) having a tetragonal structure and PbZrO₃ (PZ) having a rhombohedral structure form a solid solution, may be used. In addition, in the orientation raw material composition, the characteristics of the PZT-based material may be improved by using a composition in which at least one of Pb(Ni,Nb)O₃ (PNN), Pb(Zn,Nb)O₃ (PZN) and Pb(Mn,Nb)O₃ (PMN) is solid-solutioned as a relaxor in the PZT-based material. For example, the orientation raw material composition may be formed by solid-solutioning, as a relaxor, a PZNN-based material having a high piezoelectric characteristic, a low dielectric constant, and sinterability, in a PZT-based material by using a PZN-based material and PNN-based material. The orientation raw material composition in which the PZNN-based material is solid-solutioned as a relaxor in the PZT-based material may have an empirical formula of (1-x)Pb(Zr_{0.47}Ti_{0.53})O₃-xPb((Ni_{1-y}Zn_{y})_{1/3}Nb_{2/3})O₃. Here, x may have a value in the range of 0.1<x<0.5, preferably, have a value in the range of 0.30<x<0.32, and most preferably, have a value of 0.31. In addition, y may have a value in the range of 0.1<y<0.9, preferably, have a value in the range of 0.39<y<0.41, and most preferably have a value of 0.40. In addition, a lead-free piezoelectric material which does not contain lead (Pb) may also be used for the orientation raw material composition. Such a lead-free piezoelectric material may be a lead-free piezoelectric material which includes at least one selected from Bi_{0.5}K_{0.5}TiO₃, Bi_{0.5}Na_{0.5}TiO₃, K_{0.5}Na_{0.5}NbO₃, KNbO₃, NaNbO₃, B aTiO₃, (1-x)Bi_{0.5}Na_{0.5}TiO₃-xSrTiO₃, (1-x)Bi_{0.5}Na_{0.5}TiO₃-xBaTiO₃, (1-x) K_{0.5}Na_{0.5}NbO₃-xBi_{0.5}Na_{0.5}TiO₃, BaZr_{0.25}Ti_{0.75}O₃, etc.

The seed composition is composed of an oxide having a general formula ABO₃, and ABO₃ is an oxide having an orientable plate-like Perovskite structure, where A is composed of a bivalent metal element and B is composed of a tetravalent metal element. The seed composition composed of an oxide having a general formula ABO₃ may include at least one among CaTiO₃, BaTiO₃, SrTiO₃, PbTiO₃ and Pb(Ti,Zr)O₃. Here, the seed composition may be included in a volume ratio of 1 vol % to 10 vol % based on the orientation raw material composition. When the seed composition is included in a volume ratio of less than 1 vol %, the effect of improving the crystal orientation is insignificant, and when included in a volume ratio greater than 10 vol %, the piezoelectric performance of the piezoelectric ceramic sintered body decreases.

As described above, the piezoelectric ceramic composition including the orientation raw material composition and the seed composition is grown while having the same orientation as the seed composition through a templated grain growth (TGG) method. That is, BaTiO3 is used as a seed composition in an orientation raw material composition having the empirical formula of 0.69Pb(Zr_{0.47}Ti_{0.53})O₃-0.3 1Pb((Ni_{0.6}Zn_{0.4})_{1/3}Nb_{2/3})O₃, so that the piezoelectric ceramic sintered body not only can be sintered at a low temperature of 1000° C. or less, but also has a high piezoelectric characteristic similar to a single crystal material because the crystal orientation is improved and the amount of displacement due to an electric field can be maximized.

The seed composition which improves the crystal orientation is added to the orientation raw material composition, and the resultant is sintered to manufacture the piezoelectric ceramic sintered body. Thus, the amount of displacement according to an electric field may be maximized and the piezoelectric characteristics may be remarkably improved.

As described above, in the pressure sensor in accordance with the first exemplary embodiment, the piezoelectric layer 300 is formed between the first and second electrode layers 100 and 200 which are spaced apart from each other, and the piezoelectric layer 300 may be provided with the plurality of single-crystal piezoelectric bodies 310 having predetermined plate-like shapes. Since the plate-like piezoelectric bodies 310 are used, the piezoelectric characteristics are better than that of typical piezoelectric powder. Thus, even a slight pressure may be easily sensed, and the sensing efficiency may thereby be improved.

That is, lead zirconatetita-nate (PZT) ceramic is being widely used for piezoelectric materials mainly used now. The PZT has been improved until now while being for 80 years or more and is not further improved from the present level. In comparison, a material having an improved physical property is being demanded in fields in which piezoelectric materials are used. A single crystal is a material to meet such demand, and is a new material which can improve the performance of application elements by improving the physical property that has reached a limit by PZT ceramic. The single crystal may have a piezoelectric constant (d₃₃), which is more than two times greater than that of the polycrystal ceramic that is the main stream of typical piezoelectric material, and also have a large electromechanical coupling factor, and exhibit a superior piezoelectric characteristic.

As shown in Table 1 below, it can be found that a piezoelectric single crystal has much greater values of the piezoelectric constants (d₃₃ and d₃₁) and the electromechanical coupling factor (K33) than existing polycrystals. Such a superior physical property exhibits remarkable effects in applying the piezoelectric single crystal to an application device.

TABLE 1

| | polycrystal | single crystal |
|---|---|---|
| d33 [pC/N] | 160~338 | 500 |
| d31 [pC/N] | −50 | −280 |
| Strain [%] | ≈0.4 | ≈1.0 |

Therefore, compared to existing polycrystal ceramic, the piezoelectric single crystal is used for an ultrasonic vibrator in medical and nondestructive inspection, fish detection and the like to enable capturing of a clearer image, an ultrasonic vibrator in a washer or the like to enable stronger oscillation, and for a high-precision control actuator, such as a positioning device in a printer head and a HDD head, and a hand shaking prevention device, to enable more excellent responsibility and miniaturization.

Meanwhile, in order to manufacture a plate-like single crystal piezoelectric body, a solid single crystal growth method, the Bridgemann method, a salt fusion method, or the like may be used. After mixing a single-crystal piezoelectric body manufactured through such a method, the piezoelectric layer may be formed through a method such as printing and molding.

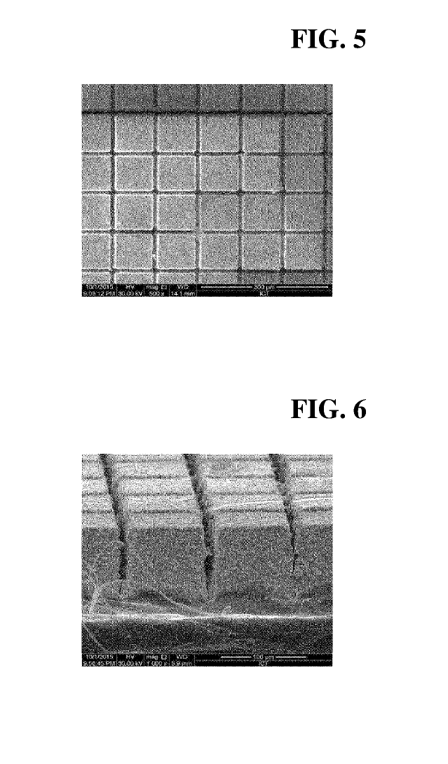

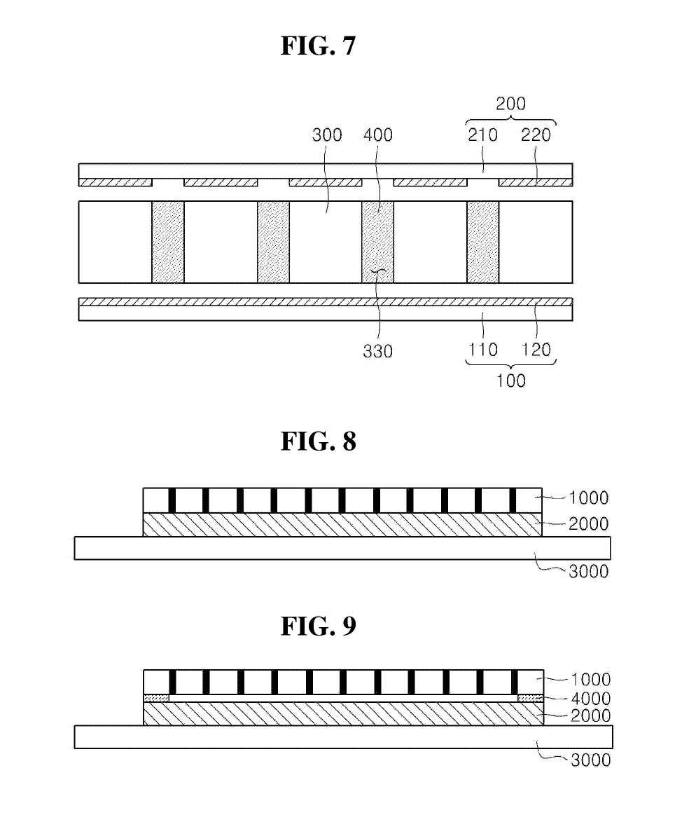

FIG. 4 is a cross-sectional view of a pressure sensor in accordance with a second exemplary embodiment. In addition, FIGS. 5 and 6 are planar and cross-sectional photographs of a pressure sensor in accordance with the second exemplary embodiment.

Referring to FIGS. 4 to 6, a pressure sensor in accordance with the second exemplary embodiment includes: first and second electrode layers 100 and 200 which are spaced apart from each other; and a piezoelectric layer 300 provided between the first and second electrode layers 100 and 200. At this point, the piezoelectric layer 300 may be formed of piezoelectric ceramic having a predetermined thickness. That is, in an exemplary embodiment, a piezoelectric layer 300 is formed such that plate-like piezoelectric bodies 310 are formed in the polymer 320, but in another exemplary embodiment, a piezoelectric layer 300 with a predetermined thickness may be formed by using piezoelectric ceramic. In addition, the same material as the piezoelectric body 310 may be used for the piezoelectric layer 300. Such a second exemplary embodiment will be described as follows while matters overlapping the descriptions of the first exemplary embodiment are omitted.

The piezoelectric layer 300 may be formed with predetermined widths and at predetermined intervals in one direction and another direction facing the one direction. That is, the piezoelectric layer 300 may be separated in plurality with predetermined widths and at predetermined intervals such that a cutaway portion 330 is formed to a predetermined depth. At this point, the cutaway portion 330 may include a plurality of first cutaway portions formed with predetermined widths in one direction, and a plurality of second cutaway portions formed with predetermined widths in another direction perpendicular to the one direction. Thus, the piezoelectric layer 300 may be divided into a plurality of unit cells having predetermined widths and predetermined intervals by the plurality of first and second cutaway portions as illustrated in FIGS. 5 and 6. At this point, the piezoelectric layer 300 may be cut away by the entire thickness, or by 50% to 95% of the entire thickness. That is, the piezoelectric layer 300 is cut away by the entire thickness or by 50% to 95% of the entire thickness, whereby the cutaway portions may be formed. As such, the piezoelectric layer 300 is cut away, whereby the piezoelectric layer 300 has a predetermined flexible characteristic. At this point, the piezoelectric layer 300 may be cut away so as to have a size of 10 μm to 5,000 μm and intervals of 1 μm to 300 μm. That is, by means of the cutaway portion 330, a unit cell may have a size of 10 μm to 5,000 μm and an interval of 1 μm to 300 μm. Meanwhile, the first and second cutaway portions of the piezoelectric layer 300 may correspond to the intervals between the electrodes of the first and second electrodes 100 and 200. That is, the first cutaway portion may be formed to correspond to the intervals between the first electrodes of the first electrode layer 100, and the second cutaway portion may be formed to correspond to the intervals between the second electrodes of the second electrode layer 200. At this point, the intervals of the electrode layers and the intervals of the cutaway portions may be the same, or the intervals of the electrode layers may be greater than or smaller than the intervals of the cutaway portions. Meanwhile, the cutaway portions may be formed by cutting away the piezoelectric layers 300 through a method such as a laser, dicing, blade cutting. In addition, the piezoelectric layer 300 may also be formed by forming cutaway portions by cutting away a material at a green bar state through a method such as laser, dicing, blade cutting, or the like, and then performing a baking process.

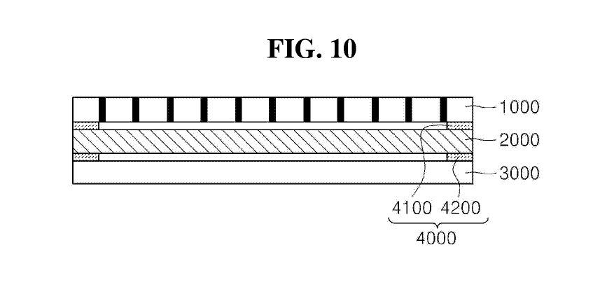

FIG. 7 is a cross-sectional view of a pressure sensor in accordance with a third exemplary embodiment.

Referring to FIG. 7, a pressure senor in accordance with the third exemplary embodiment may include: first and second electrode layers 100 and 200 which are spaced apart from each other; a piezoelectric layer 300 which is provided between the first and second electrode layers 100 and 200 and has a plurality of cutaway portions 330 formed therein in one direction and another direction; and an elastic layer 400 formed in the cutaway portions 330 of the piezoelectric layer 300. At this point, the cutaway portions 330 may be formed over the entire thickness of the piezoelectric layer 300 and formed in a predetermined thickness. That is, the cutaway portions 330 may be formed to a thickness of 50% to 100% of the thickness of the piezoelectric layer 300. Accordingly, the piezoelectric layer 300 may be divided into unit cells spaced predetermined distances apart from each other in one direction and another direction by the cutaway portions 330, and the elastic layer 400 may be formed between the unit cells.

The elastic layer 400 may be formed by using a polymer, silicon, or the like which has elasticity. Since the piezoelectric layer 300 is cut away and the elastic layer 400 is formed, the piezoelectric layer 300 may have higher flexible characteristic than other exemplary embodiments in which the elastic layer 400 is not formed. That is, when the cutaway portions 330 are formed in the piezoelectric layer 300, but the elastic layer is not formed, the flexible characteristic of the piezoelectric layer 300 may be restricted. However, the piezoelectric layer 300 is entirely cut away and the elastic layer 400 is formed, whereby the flexible characteristic may be improved in such a degree that the piezoelectric layer 300 can be rolled. Of course, the elastic layer 400 may be formed such that the cutaway portions 330 are not formed over the entire thickness of the piezoelectric layer 300, but as illustrated in FIGS. 4 to 6, the elastic layer 400 may be formed such that the cutaway portions 330 formed in a portion of the thickness are filled with the elastic layer 400.

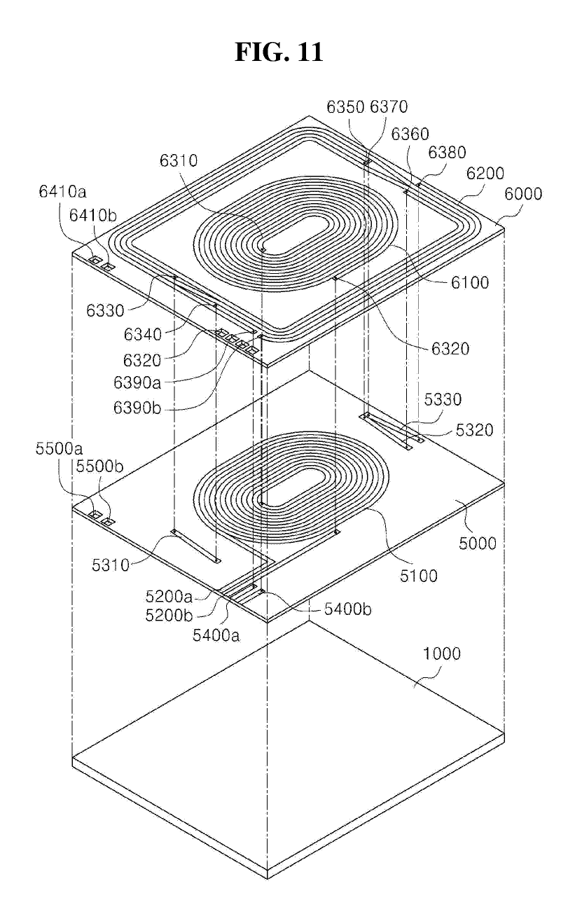

Meanwhile, the pressure sensor in accordance with exemplary embodiments may be implemented as a complex device by being combined with a haptic device, a piezoelectric buzzer, a piezoelectric speaker, NFC, WPC, magnetic secure transmission, or the like. In addition, the pressure sensor in accordance with exemplary embodiments may also be used as a fingerprint recognition sensor. That is, the pressure sensor in accordance with exemplary embodiments may implement a complex device by being coupled with a functioning part which serves a different function from the pressure sensor. A complex device provided with a piezoelectric sensor in accordance with an exemplary embodiment is illustrated in FIGS. 8 to 10. Here, in a pressure sensor 1000, any one structure in various exemplary embodiments described using FIGS. 1, 4, and 7 may be used.

As described in FIG. 8, a piezoelectric device 2000 may be formed on a vibration plate 3000, and the pressure sensor 1000 in accordance with exemplary embodiments may be provided above a piezoelectric device 2000.

The piezoelectric device 2000 may be formed in a bimorph type having a piezoelectric layer on both surfaces of a substrate, and may also be formed in a unimorph type having a piezoelectric layer on one surface of the substrate. The piezoelectric layer may be formed such that at least one layer is stacked, or preferably, a plurality of piezoelectric layers may be stacked. In addition, electrodes may be formed on upper and lower portion of the piezoelectric layer. That is, the piezoelectric device 2000 may be implemented by stacking a plurality of piezoelectric layers and a plurality of electrodes alternately. Here, the piezoelectric layer 300 may be formed by using the same material as the piezoelectric layer 300, for example, a piezoelectric material based on PZT (Pb, Zr, Ti), NKN (Na, K, Nb), and BNT (Bi, Na, Ti). In addition, the piezoelectric layer may be stacked and formed by being polarized in directions different from each other or in the same direction. That is, when a plurality of piezoelectric layers are formed on one surface of the substrate, polarization may be alternately formed in directions different from each other or in the same direction in each piezoelectric layer. Meanwhile, for the substrate, a material having a characteristic of generating a vibration while maintaining the structure in which the piezoelectric layer is stacked, for example, metal, plastic, etc. may be used. Meanwhile, the piezoelectric device 2000 may have electrode pattern (not shown) in at least one region thereof to which a drive signal is applied. For example, the electrode pattern may be provided on an upper surface of the piezoelectric device 2000 or on edges of a lower surface of the piezoelectric device 2000. At least two electrode patterns may be formed spaced apart from each other, may be connected to a connecting terminal (not shown), and may be connected to an electronic apparatus through the connecting terminal. At this point, when the electrode pattern is formed on the lower portion of the piezoelectric device 2000, the electrode pattern may preferably be insulated from the vibration plate 3000, and to this end, an insulation film may be formed between the piezoelectric device 2000 and the vibration plate 3000.

The vibration plate 3000 may be provided so as to have the same shape as the piezoelectric device 2000 and the pressure sensor 1000, and may be provided larger than the piezoelectric device 2000. The piezoelectric device 2000 may be adhered with an adhesive on the upper surface of the vibration plate 3000. Metal or a polymer- or pulp-based material may be used for such a vibration plate 3000. For example, a resin film may be used for the vibration plate 3000, and a material having the young's modulus of 1 MPa to 10 GPa and a large loss coefficient, such as, an ethylene propylene rubber-based material and a styrene butadiene rubber-based material may be used. Such a vibration plate 3000 amplifies the vibration of the piezoelectric device 2000.

As such, the piezoelectric device 2000 provided between the vibration plate 3000 and the pressure sensor 1000 may be operated as a piezoelectric acoustic device or a piezoelectric vibration device according to a signal applied through an electronic apparatus, that is, an alternating current power source. That is, the piezoelectric device 2000 may be used, according to an applied signal, as an actuator which generates a predetermined vibration, that is, as a haptic device, or may be used as a piezoelectric buzzer or a piezoelectric speaker which generates a predetermined sound.

Meanwhile, the piezoelectric sensor 1000 and the piezoelectric device 2000 may be adhered with an adhesive or the like, and may also be integrally formed. When the pressure sensor 1000 and the piezoelectric device 2000 are integrally manufactured, the pressure sensor 1000 can have the structure described by using FIGS. 4 and 7. That is, the second electrode may be formed on a portion in which a plurality of piezoelectric layers and electrodes are alternately stacked and an upper portion thereof, and the piezoelectric layer 300 is formed on the second electrode, and the first electrode is formed on the piezoelectric layer. At this point, the second electrode is formed by patterning, the piezoelectric layer 300 may be cut away and divided into predetermined unit cells by a plurality of cutaway portions, and the first electrode may be formed on the piezoelectric layer by patterning.

In addition, when the piezoelectric device 2000 is used as a piezoelectric buzzer or a piezoelectric speaker, preferably, a predetermined resonance space is provided between the piezoelectric device 2000 and the pressure sensor 1000. That is, as illustrated in FIG. 9, a support 4000 with a predetermined thickness may be provided on an edge between the piezoelectric device 2000 and the pressure sensor 1000. A polymer may be used for the support 4000. According to the height of the support 4000, the size of the resonance space between the piezoelectric device 2000 and the pressure sensor 1000 may be adjusted. Meanwhile, the support 4000 may also be implemented such that an adhesive tape or the like are provided along the periphery of the piezoelectric device 2000 and the pressure sensor 1000. In addition, as illustrated in FIG. 10, not only a first support 4100 may be provided on an edge between the piezoelectric device 2000 and the pressure sensor 1000, but also a second support 4200 may also be provided between piezoelectric device 2000 and the vibration plate 3000, whereby a predetermined resonance space may be provided.

FIGS. 11 and 12 are an exploded perspective view and an assembled perspective view of a complex device including an NFC and a WPC according to an example of a complex device provided with a pressure sensor in accordance with an exemplary embodiment. Of course, the pressure sensor may be coupled to each of an NFC, a WPC, and an MFC, and these NFC, WPC, and MST may be configured from a predetermined antenna pattern.

Referring to FIGS. 11 and 12, a complex device may include: a first sheet 5000 which is provided on one surface of the pressure sensor 1000 and has an antenna pattern 5100 formed thereon; and a second sheet which is provided on or under the first sheet 5000 or on the same surface as the first sheet and has a second antenna pattern 6100 and a third antenna pattern 6200 which are formed thereon. Here, the first antenna pattern 5100 of the first sheet 5000 and the second antenna pattern 6100 of the second sheet 6000 are connected to each other and thereby form a wireless power charge (WPC) antenna, and the third antenna pattern 6200 of the second sheet 6000 is formed outside the second antenna pattern 6100 and thereby forms a near field communication (NFC) antenna. That is, the complex device module in accordance with an exemplary embodiment may be provided such that a pressure sensor, a WPC antenna, an NFC antenna are integrated.

The first sheet 5000 is provided on one surface of the pressure sensor 1000 and has the first antenna pattern 5100 formed thereon. In addition, the first sheet 5000 is provide with: first and second extracting patterns 5200a and 5200b which are connected to the first antenna pattern 5100 and extracted to the outside; a plurality of connection patterns 5310, 5320 and 5330 which connect the third antenna pattern 6200 formed on the second sheet 6000; and third and fourth extracting patterns 5400a and 5400b which are connected to the third antenna pattern 6200 and extracted to the outside. Such a first sheet 0 5000 may be provided in the same shape as the pressure sensor 1000. That is, the first sheet 5000 may be provided in an approximately rectangular plate-shape. At this point, the thickness of the first sheet 5000 may be equal to or different from that of the pressure sensor 1000. The first antenna pattern 5100 may be formed in a predetermined number of turns, for example, by rotating in one direction from a central part of the first sheet 5000. For example, the first antenna pattern 5100 may be formed in a spiral shape which has a predetermined width and intervals and outwardly rotates counterclockwise. At this point, the wire widths and intervals of the first antenna pattern 5100 may be the same or different from each other. That is, the first antenna pattern 5100 may have the wire width greater than interval. Also, the end of the first antenna pattern 5100 is connected to the first extracting pattern 5200a. The first extracting pattern 5200a is formed with a predetermined width and formed to be exposed toward one side of the first sheet 5000. For example, the first extracting pattern 5200a is formed to extend in the longitudinal direction of the first sheet 5000 and be exposed to one short side of the first sheet 5000. In addition, the second extracting pattern 5200b is spaced apart from the first extracting pattern 5200a and is formed in the same direction as the first extracting pattern 5200a. Such a second extracting pattern 5200b is connected to the second antenna pattern 6100 formed on the second sheet 6000. Here, the second extracting pattern 5200b may be formed longer than the first extracting pattern 52000a. In addition, a plurality of connection patterns 5310, 5320 and 5330 are provided to connect the third antenna pattern 6200 formed on the second sheet 6000. That is, the third antenna pattern 6200 is formed in, for example, a semi-circular shape in which at least two regions are disconnected, and a plurality of connection patterns 5210, 5220, and 5230 are formed on the first sheet 5000 to connect the two regions to each other. The connection pattern 5210 is formed with predetermined width and length in the direction of one short side in a region between the first extracting patterns 5200a. The connection patterns 5220 and 5230 are formed on the position facing the connection pattern 5210 in the long-side direction, that is, on the other short side on which the first and second extraction patterns 5200a and 5200b are not formed, and are formed with predetermined widths and lengths on the other short side in the direction of the other short side without being exposed to the other short side. In addition, the connection patterns 5220 and 5230 are formed to be spaced apart from each other. In addition, the third and fourth extracting patterns 5400a and 5400b are formed to be spaced apart from the second extracting pattern 5200b, and formed to be exposed to the one short side. Meanwhile, through holes 5500a and 5500b are formed to be individually separated in the region in which the extracting patterns 5200 and 5400 of one side on which the extracting patterns 8200 and 8400 are formed are not formed. In addition, the extracting patterns 5200 and 5400 are connected to the connection terminal (not shown) and connected to an electronic device through the terminal. Meanwhile, the first sheet 5000 may be manufactured by using magnetic ceramic. For example, the first sheet 5000 may be formed by using NiZnCu- or NiZn-based magnetic body. Specifically, in the NiZnCu-based magnetic sheet, Fe₂O₃, ZnO, NiO, CuO may be added as a magnetic body, and Fe₂O₃, ZnO, NiO, and CuO may be added in a ratio of 5:2:2:1. As such, the first sheet 5000 is manufactured by using magnetic ceramic, and thus, an electromagnetic wave generated from the WPC antenna and the NFC antenna may be shielded or absorbed. Thus, the interference of the electromagnetic wave may be suppressed.

The second sheet 6000 is provided on the first sheet 5000, and the second antenna pattern 06100 and the third antenna pattern 6200 are formed to be spaced apart from each other. In addition, a plurality of holes 6310, 6320, 6330, 6340, 6350, 6360, 6370, and 6380 are formed in the second sheet 6000. Such a second sheet 6000 may be provided in the same shape as the pressure sensor 1000 and the first sheet 5000. That is, the second sheet 6000 may be provided in an approximately rectangular plate-shape. At this point, the thickness of the second sheet 6000 may be equal to or different from those of the pressure sensor 1000 and the first sheet 5000. That is, the second sheet 6000 may be provided in a smaller thickness than the pressure sensor 1000 and the same thickness as the first sheet 5000. The second antenna pattern 6100 may be formed in a predetermined number of turns, for example, by rotating in one direction from a central part of the second sheet 6000. For example, the second antenna pattern 6100 may be formed in a spiral shape which has a predetermined width and interval and outwardly rotates clockwise. That is, the second antenna pattern 6100 may be formed in a spiral shape rotating clockwise from the same region as the first antenna pattern 5100 formed on the first sheet 5000, and formed up to the region overlapping the second extraction pattern 5200b formed on the first sheet 5000. At this point, the wire width and the interval of the second antenna pattern 6100 may be the same as the wire width and the interval of the first antenna pattern 5100, and the second antenna pattern 6100 and the first antenna pattern 5100 may overlap. In the starting position and the end position of the second antenna pattern 6100, holes 6310 and 6320 are respectively formed, and the holes 6310 and 6320 are filled with a conductive material. Accordingly, the starting position of the second antenna pattern 6100 is connected to the starting position of the first antenna pattern 5100 through the hole 6310, and the end position of the second antenna pattern 6100 is connected to a predetermined region of the second extracting pattern 5200b through the hole 6320. The third antenna pattern 6200 is formed to be spaced apart from the second antenna pattern 6100 and is formed in a plurality number of turns along the periphery of the second sheet 6000. That is, the third antenna pattern 6200 is provided to surround the second antenna pattern 6100 from the outside. At this point, the third antenna pattern 6200 is formed in a shape disconnected in a predetermined region on the second sheet 6000. That is, the third antenna pattern 6200 is not formed in a plurality of numbers of turns connected to each other, but may be formed in a shape disconnected in at least two regions and electrically disconnected from each other on the second sheet 6000. As such a plurality of holes 6330, 6340, 6350, 6360, 6370 and 6380 are formed between the third antenna patterns 6200 disconnected from each other. Also, the plurality of holes 6330, 6340, 6350, 6360, 6370 and 6380 are filled with a conductive material and respectively connected to the connection patterns 5310, 5320 and 5330 of the first sheet 5000. Accordingly, the third antenna pattern 6200 is formed in a form which is disconnected in at least two regions, but may electrically be connected to each other through the plurality of holes 6330, 6340, 6350, 6360, 6370 and 6380 and the connection patterns 5310, 5320 and 5330 of the first sheet 5000. In addition, in the second sheet 6000, a plurality of through holes 6410 and 6420, which respectively expose the through holes 5500a and 5500b of the first sheet 5000 and the plurality of extracting patterns 5200 and 5400, are formed. In addition, the four through holes 6420 are formed so as to expose the plurality of, that is, four extracting patterns 5200 and 5400 of the first sheet 5000. Meanwhile, the second sheet 6000 may be manufactured by using a material different from that of the first sheet 5000. For example, the second sheet 6000 may be manufactured by using nonmagnetic ceramic, that is, manufactured by using low temperature co-fired ceramic (LTCC).

Meanwhile, the antenna patterns 5100, 6100 and 6200, extracting patterns 5200 and 5400, connection patterns 5310, 5320 and 5330, and the like are formed by using copper foils or a conductive paste, and when formed by using the conductive paste, the conductive paste may be printed on the sheet through various printing methods. As conductive particles of the conductive paste, metal particles of gold (Au), silver (Ag), nickel (Ni), copper (Cu), palladium (Pd), silver-coated copper (Ag coated Cu), silver-coated nickel (Ag coated Ni), nickel-coated copper (Ni coated Cu), and nickel-coated graphite (Ni coated graphite), carbon nanotubes, carbon black, graphite, silver-coated graphite (Ag coated graphite), or the like may be used. The conductive paste is a material, in which conductive particles are uniformly dispersed in a fluidic organic binder, is applied on a sheet through a method such as printing, and thereby exhibits electrical conductivity by heat treatment, such as, drying, cure, and baking. In addition, as a printing method, planography such as screen printing, roll-to-roll printing such as gravure printing, inkjet printing, or the like may be used.

As described above, the complex device module in accordance with an exemplary embodiment may be manufactured by integrating a pressure sensor, a WPC antenna, and an NFC antenna. Accordingly, by using one module, an input of an electronic device may be sensed by using one module, an electronic device may be wirelessly charged, and short-range communication can be performed. Of course, the complex device module may also be manufactured such that a pressure sensor and at least one among a piezoelectric speaker, a piezoelectric actuator, a WPC antenna, an NFC antenna and an MST antenna are integrated. In addition, multiple functions are achieved with one module, and thus, compared to a case in which each of the functions is individually provided, the area of the region occupied in the case may be reduced.

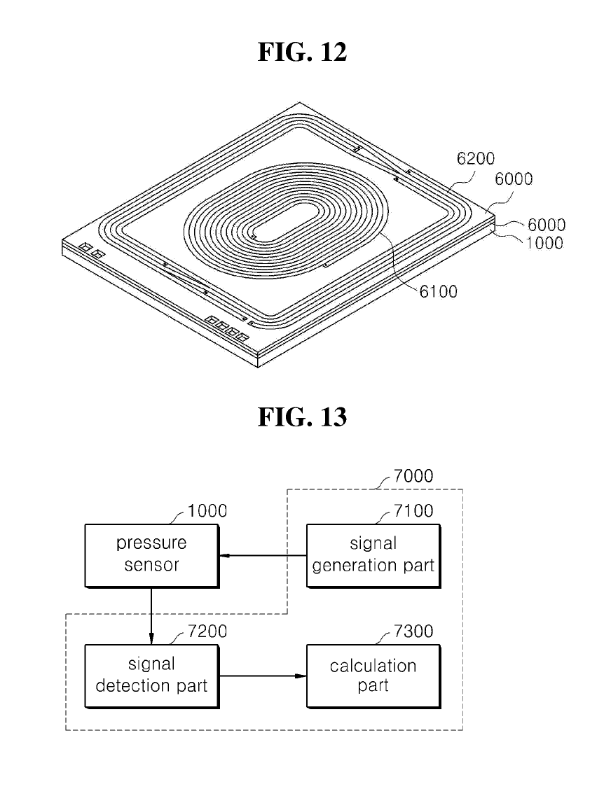

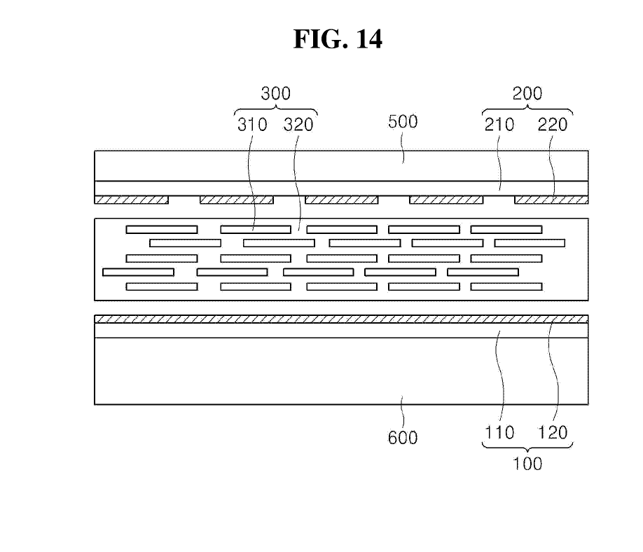

FIG. 13 is a configuration diagram of a fingerprint recognition sensor employing a pressure sensor in accordance with an exemplary embodiment, and FIG. 14 is a cross-sectional view of a pressure sensor in accordance with a second exemplary embodiment.

Referring to FIG. 13, a fingerprint recognition sensor employing a pressure sensor in accordance with an exemplary embodiment may include: a pressure sensor 1000; and a fingerprint detection part 7000 which is electrically connected to the pressure sensor 1000 and detects a fingerprint. In addition, the fingerprint part 7000 may include a signal generation part 7100, a signal detection part 7200, a calculation part 7300, and the like.

Meanwhile, as illustrated in FIG. 14, the pressure sensor 1000 may further be provided with a protective layer 500 as a protective coating for the surface on which a finger is placed. The protective layer 500 may be manufactured by using urethane or another plastic which can function as a protective coating. The protective layer 500 is adhered to a second electrode layer 200 by using an adhesive. In addition, the pressure sensor 1000 may further include a support layer 600 which can be used as a support inside the pressure sensor 1000. The support layer 600 may be manufactured by using Teflon or the like. Of course, another type of supporting materials may be used for the support layer 600. The support layer 600 is adhered to a first electrode layer 100 by using an adhesive. Meanwhile, as illustrated in FIG. 4, the pressure sensor 1000 of an exemplary embodiment may be provided such that the piezoelectric layer 300 is divided into unit cells spaced predetermined distances apart from each other in one direction and another direction by the cutaway portions 330, and as illustrated in FIG. 7, the elastic layer 400 may be formed on the cutaway portion 3300. In this case, it is desirable that the formed elastic layer 400 prevent respective vibrations from affecting each other.

The fingerprint detection part 7000 may be connected to each of the first and second electrodes 110 and 210 which are provided on and under the piezoelectric layer 300 of the pressure sensor 1000. The fingerprint part 7000 may generate an ultrasonic signal by vertically vibrating the piezoelectric layer 300 by applying, to the first and second electrodes 110 and 210, a voltage having a resonant frequency of an ultrasonic band.

The signal generation part 7100 is electrically connected to the plurality of first and second electrodes 110 and 210 which are included in the pressure sensor 1000, and applies, to each electrode, an alternating current voltage having a predetermined frequency. While the piezoelectric layer 300 of the pressure sensor 1000 is vertically vibrated by the alternating current voltage applied to the electrodes, an ultrasonic signal having a predetermined resonant frequency, such as 10 MHz, is emitted to the outside.

A specific object may contact one surface on the pressure sensor 1000, for example, one surface of the protective layer 500. When the object contacting the one surface of the protective layer 500 is a human finger including a fingerprint, the reflective pattern of the ultrasonic signal emitted by the pressure sensor 1000 is differently determined according to the fine valleys and ridges which are present in the fingerprint. Assuming a case in which no object contacts a contact surface such as the one surface of the protective layer 500, most of the ultrasonic signal generated from the pressure sensor 1000 due to the difference in media between the contact surface and air cannot pass through the contact surface but is reflected and returned. On the contrary, when a specific object including a fingerprint contacts the contact surface, a portion of the ultrasonic signal which is generated from the pressure sensor 1000 and directly contact the ridges of the fingerprint passes through the interface between the contact surface and the fingerprint, and only a portion of the generated ultrasonic signal is reflected and returned. As such, the strength of the reflected and returned ultrasonic signal may be determined according to the acoustic impedance of each material. Consequently, the signal detection part 7200 measures, from the pressure sensor 100, the difference in the acoustic impedance generated by the ultrasonic signal at the valleys and ridges of the fingerprint, and may determine whether the corresponding region is the sensor contacting the ridges of the fingerprint.

The calculation part 7300 analyzes the signal detected by the signal detection part 7200 and calculates a fingerprint pattern. The pressure sensor 1000 in which a low-strength reflected signal is generated is the pressure sensor 1000 contacting the ridges of the fingerprint, and the pressure sensor 1000 in which a high-strength signal is generated—ideally, the same strength as the strength of the output ultrasonic signal—is the pressure sensor 1000 core\responding to the valleys of the fingerprint. Accordingly, the fingerprint pattern may be calculated from the difference in the acoustic impedance detected for each region of the pressure sensor 1000.

Meanwhile, a pressure sensor in accordance with an exemplary embodiment may be implemented as a electrostatic capacitance-type pressure sensor such that a piezoelectric layer 300 is not provided and first and second electrode layers 100 and 200 are spaced a predetermined distance apart from each other. That is, between the first and second electrode layers 100 and 200, at least one among an air gap, a void, or a high-permittivity layer is formed, the distance between the first and second electrode layers 100 and 200 are adjusted by a touch pressure. Thus, the electrostatic capacitance is adjusted and the electrodes may function as a pressure sensor. Here, the high-permittivity layer may be formed of a high-permittivity material which has the permittivity, such as 4 or higher, which is higher than that of silicon, rubber, or the like, and may be formed such that the high-permittivity material is mixed with a insulating material such as silicon. In addition, in an exemplary embodiment, an electrostatic capacitance-type pressure sensor may also be achieved by mixing an air gap or void with a high-permittivity layer. That is, at least one air gap or void may be formed in the high-permittivity layer. Thus, exemplary embodiments may be implemented by using a piezoelectric pressure sensor and an electrostatic capacitance-type pressure sensor. Also in the case of using an electrostatic capacitance-type pressure sensor, the complex device described by using FIGS. 8 to 14 may be achieved. That is, the complex device module may also be manufactured such that an electrostatic capacitance-type pressure sensor and at least one among a piezoelectric speaker, a piezoelectric actuator, a WPC antenna, an NFC antenna and an MST antenna are integrated.

The present invention may, however, be embodied in different forms and should not be construed as limited to the embodiments set forth herein. That is, the above embodiments are provided so that this invention will be thorough and complete, and will fully convey the scope of the present invention to those skilled in the art, and the scope of the present invention should be understood by the scopes of claims of the present application.

1. A pressure sensor comprising:
first and second electrode layers provided to be spaced apart from each other and respectively comprising first and second electrodes facing each other; and
a piezoelectric layer provided between the first and second electrode layers, wherein the piezoelectric layer comprises a plurality of plate-like piezoelectric bodies in a polymer.

2. The pressure sensor of claim 1, wherein the piezoelectric bodies are arranged in plurality in one direction and another direction crossing each other in a horizontal direction and are arranged in plurality in a vertical direction.

3. The pressure sensor of claim 1, wherein the piezoelectric bodies are provided to have densities of 30% to 99%.

4. The pressure sensor of claim 1, wherein the piezoelectric bodies are single crystals.

5. The pressure sensor of claim 3, wherein the piezoelectric bodies each comprises a seed composition formed of:
an orientation raw material composition composed of a piezoelectric material having a Perovskite crystalline structure; and
an oxide which is distributed in the orientation raw material composition and has a general formula ABO₃ (A is a bivalent metal element, and B is a tetravalent metal element).

6. A pressure sensor comprising:
first and second electrode layers provided to be spaced apart from each other and respectively comprising first and second electrodes facing each other;
a piezoelectric layer provided between the first and second electrode layers; and
a plurality of cutaway portions formed with predetermined widths and at a predetermined depth in the piezoelectric layer.

7. The pressure sensor of claim 6, wherein the cutaway portions are formed to a depth of 50% to 100% of a thickness of the piezoelectric layer.

8. The pressure sensor of claim 7, wherein the cutaway portions are formed such that at least one thereof corresponds to an interval between the plurality of first and second electrodes which are arranged at predetermined intervals.

9. The pressure sensor of claim 6, further comprising an elastic layer provided inside the cutaway portions.

10. The pressure sensor of claim 6, wherein the piezoelectric layer is single-crystalline.

11. The pressure sensor of claim 6, wherein the piezoelectric layer comprises a seed composition formed of:
an orientation raw material composition composed of a piezoelectric material having a Perovskite crystalline structure; and
an oxide which is distributed in the orientation raw material composition and has a general formula ABO₃ (A is a bivalent metal element, and B is a tetravalent metal element).

12. A complex device comprising:
a pressure sensor set forth in claim 1; and
at least one functional part having a function different from that of the pressure sensor.

13. The complex device of claim 12, wherein the functional part comprises: a piezoelectric device provided on one side of the pressure sensor; and a vibration plate provided on one side of the piezoelectric device.

14. The complex device of claim 13, wherein the piezoelectric device is used as a piezoelectric vibration apparatus or a piezoelectric acoustic apparatus according to a signal applied thereto.

15. The complex device of claim 12, wherein the functional part is provided on one side of the pressure sensor and comprises at least one among an NFC, a WPC, and an MST each of which comprises at least one antenna pattern.

16. The complex device of claim 12, wherein the functional part comprises:
a piezoelectric device provided on one surface of the pressure sensor;
a vibration plate provided on one surface of the piezoelectric device; and
at least one among an NFC, a WPC, and an MST which are provided on the other surface of the pressure sensor or on one surface of the vibration plate.

17. The complex device of claim 12 comprising a fingerprint detection part electrically connected to the pressure sensor and configured to measure, from the pressure sensor, a difference in acoustic impedance generated by an ultrasonic signal at valleys and ridges of the fingerprint and thereby detects the fingerprint.
